(19) United States
(12) Patent Application Publication
(10) Pub. No.: US 2007/0079166 A1
(43) Pub. Date: Apr. 5, 2007

(54) Compensated-clock generating circuit and USB device having same

(75) Inventors: Emi Okada, Kanagawa (JP); Makoto Mizokuchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/529,432

(22) Filed: Sep. 29, 2006

(30) Foreign Application Priority Data
Sep. 30, 2005 (JP) 2005-285968

(51) Int. Cl. G06F 1/00

(52) U.S. Cl. 713/500

(57) ABSTRACT

A compensated-clock generating circuit that complies with USB specifications includes an oscillating circuit that generates clock pulses; a counting circuit that counts the number of clock pulses from the oscillating circuit based upon a regular prescribed signal in accordance with a USB downstream signal; and a frequency compensation value generating circuit that compares the value counted by the counting circuit and a prescribed reference value and obtaining a compensation value. The oscillation frequency of the oscillating circuit is corrected to a prescribed value in response to receipt of the compensation value from the frequency compensation value generating circuit. Compensation is applied based upon a highly accurate signal that is based upon USB specifications, thereby making it possible to generate pulses of higher accuracy even if the accuracy of the oscillation frequency per se of the oscillator in the oscillation circuit is low.

### FIELD OF THE INVENTION

This invention relates to a compensated-clock generating circuit and, more particularly, to a compensated-clock generating circuit for realizing a frequency accuracy that is in compliance with USB specifications, and to a USB device equipped with this circuit.

### BACKGROUND OF THE INVENTION

The application of USB specifications to personal computers and the like has become commonplace in recent years. It is required, therefore, that terminals such as keyboards, mouses and scanners also have a data transfer rate that falls within a prescribed precision tolerance in accordance with USB specifications. These terminals that have been adapted so as to meet the USB specifications generally are referred to as “USB devices”. USB specifications are of various types, such as low-speed and full-speed specs. In the case of full speed, for example, which is in wide application, an accuracy of ±0.25% is required for the data transfer rate. In order to satisfy this requirement, it is necessary to raise clock accuracy in excess of this value as a matter of course. To achieve this, a well-known method is to use an externally mounted crystal oscillator having a high accuracy but a drawback is that this leads to additional cost. It is preferred, therefore, that an internal oscillator be used. At present, however, oscillators that are incorporated in microcomputers employed in terminals do not have the required frequency accuracy. It is necessary that this accuracy be raised.

As a measure for solving this problem, the specification of Patent Document 1 discloses employing an oscillator having a frequency higher than the frequency used and a pulse filter that suppresses pulses, thereby obtaining a stabilized clock.

As illustrated in FIG. 1, such an arrangement includes an internal clock generator 51, a pulse counter 52 connected to the internal clock generator 51, a pulse-number memory 53 capable of storing the number of clock pulses generated, and a pulse filter 54 for ascertaining the number of pulses to be filtered out and extracting a stabilized clock. The arrangement further includes a synchronization decoder 55 for deciding the timings of the pulse counter 52 and pulse-number memory 53, a frequency divider 56 for generating a necessary frequency, and a data signal decoder 57 that produces an output for further processing.

In terms of operation, the internal clock generator 51 used has a frequency higher than the required clock frequency, and counting of the number of clock pulses from the internal clock generator 51 is started by the pulse counter 52 in response to a pulse from the synchronization decoder 55. The number of pulses counted is stored in the pulse-number memory 53 in response to the next pulse from the synchronization decoder 55. On the basis of the value in the pulse-number memory 53 and a predetermined number of pulses, the pulse filter 54 ascertains the number of pulses to be filtered out and filters the clock signal and makes it conform to the predetermined value to thereby stably supply a clock having a prescribed frequency accuracy.

The specification of Patent Document 2 discloses a clock oscillation circuit that automatically trims an oscillated frequency based on a clock applied externally.

[Patent Document 1] Japanese Patent Kohyo Publication No. JP-P2004-507812A (WO2002/017047 (PCT/DE2001/003187))

[Patent Document 2] Japanese Patent Kokai Publication No. JP-P2000-341119A

The entire disclosure of these documents are incorporated herein by reference thereto.

### SUMMARY OF THE DISCLOSURE

Patent Document 1 is outstanding in that it does not require use of a costly crystal oscillator. However, it raises clock accuracy by using an oscillator that has a frequency considerably higher than the frequency used and filtering out superfluous pulses. Since an oscillator having a frequency considerably higher than the frequency used is employed and use is made of a filtering circuit, a problem which arises is a major increase in cost.

Accordingly, it is an object of the present invention to provide at low cost a compensated-clock generating circuit having an accuracy that can comply with USB specifications and the like, as well as a device having this circuit.

According to a first aspect of the present invention, there is provided a compensated-clock generating circuit comprising: an oscillating circuit that generates clock pulses; a counting circuit that counts the number of clock pulses from the oscillating circuit based upon a regular prescribed signal in accordance with a USB downstream signal; and a frequency compensation value generating circuit that compares the value counted by the counting circuit and a prescribed reference value and obtaining a compensation value; wherein oscillation frequency of the oscillating circuit is corrected to a prescribed value in response to receipt of the compensation value from the frequency compensation value generating circuit.

In other words, the present invention is characterized by counting the oscillation frequency of an oscillating circuit based upon a highly accurate signal that is based upon USB specifications in accordance with a USB downstream signal, comparing this with a prescribed value, outputting a compensation value to the oscillating circuit based upon the difference between the compared signals, and adjusting the oscillation frequency based upon the compensation value. As a result, even if the accuracy of the oscillation frequency of the oscillator in the oscillating circuit is low, pulses having a frequency of a higher accuracy can be generated.

In a second aspect of the present invention, the counting circuit has a trigger generating circuit that generates a trigger in response to receipt of the prescribed signal; the counting circuit counting the number of clock pulses from the oscillating circuit in response to receipt of the trigger.

In a third aspect of the present invention, the compensated-clock generating circuit further comprises a trigger generating circuit that generates a trigger in response to receipt of the prescribed signal; the counting circuit counting the number of clock pulses from the oscillating circuit in response to receipt of the trigger.

In a fourth aspect of the present invention, the prescribed signal is an SOF that is based upon USB specifications.

In a fifth aspect of the present invention, the prescribed signal is generated by a USB macro provided in the compensated-clock generating circuit.

In a sixth aspect of the present invention, the oscillating circuit includes a frequency compensation register and an oscillator that generates clock pulses; a compensation value from the frequency compensation value generating circuit being held in the frequency compensation register, and oscillation frequency of the oscillator being corrected based upon an output from the frequency compensation register.

In a seventh aspect of the present invention, the compensated-clock generating circuit is built in a single semiconductor chip.

In a eighth aspect of the present invention, there is provided a USB device having the compensated-clock generating circuit according to the preceding aspects.

The meritorious effects of the present invention are summarized as follows.

In accordance with the present invention, a compensated-clock generating circuit that satisfies the accuracy of USB specifications and a USB device having this circuit are obtained at low cost.

### BRIEF DESCRIPTION OF THE DRAWINGS

FIG. 1 is a block diagram of a prior art;

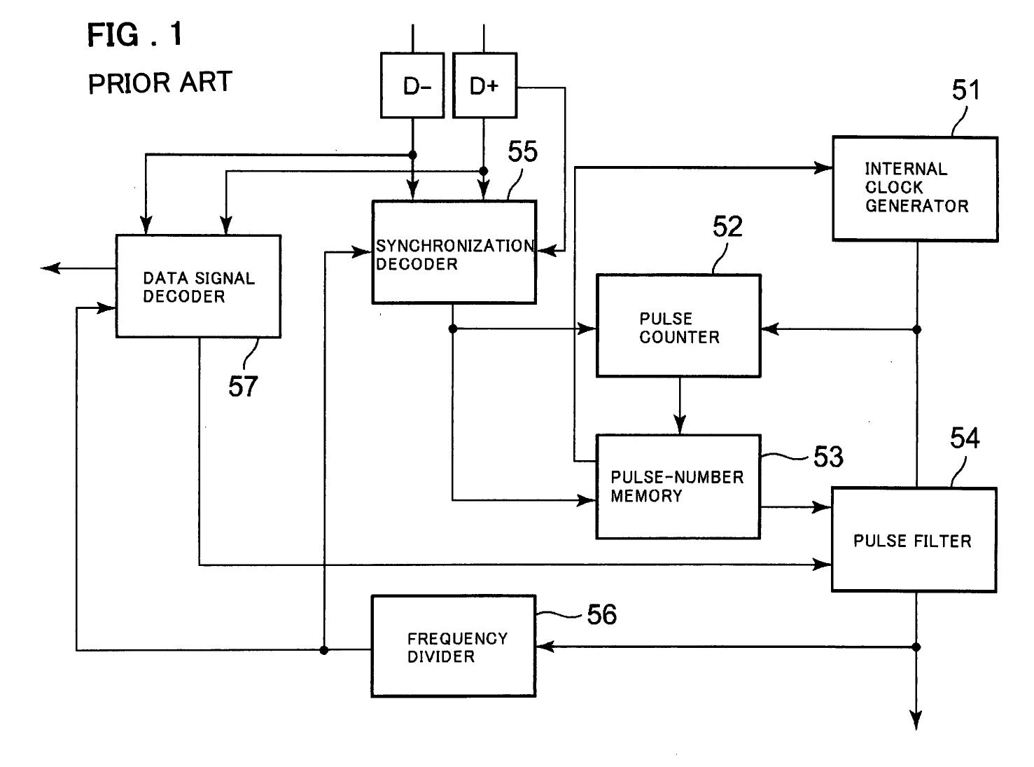

FIG. 2 is an explanatory view illustrating structural features of the present invention;

FIG. 3 is a block diagram illustrating a first embodiment of the present invention;

FIG. 4 is a timing chart according to the first embodiment;

FIG. 5 is a flowchart according to the first embodiment;

FIG. 6 schematically illustrates an oscillator used in the first embodiment and is useful in describing a compensating operation; and

FIG. 7 is a block diagram illustrating a second embodiment of the present invention.

### PREFERRED EMBODIMENTS OF THE INVENTION

Preferred embodiments of the present invention will now be described in detail with reference to the drawings.

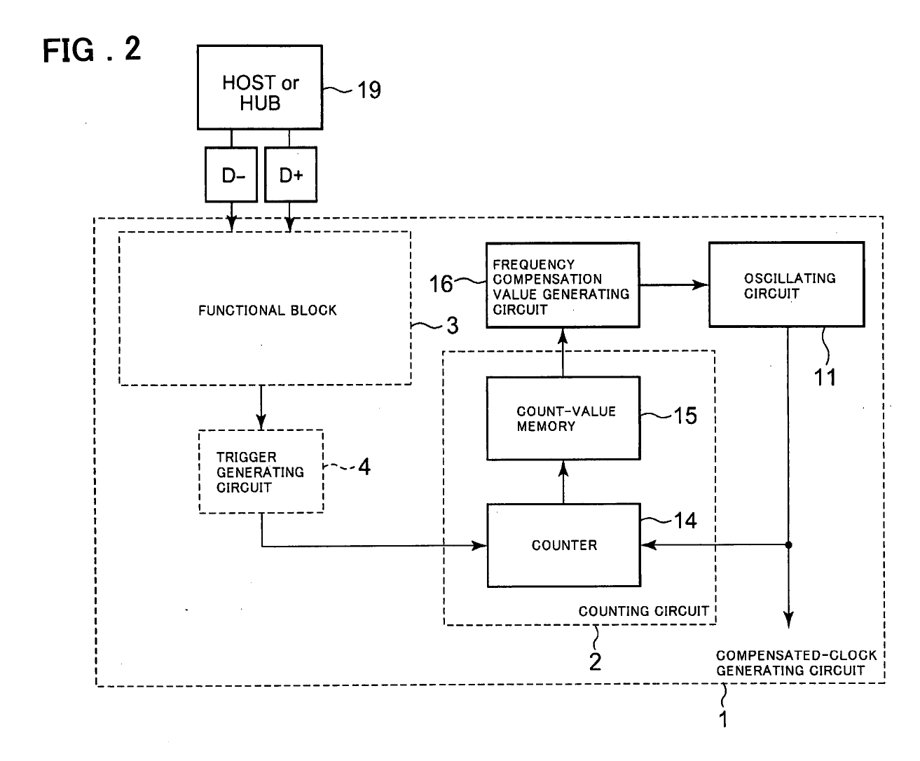

Reference will be had to FIG. 2 to describe structural features representing the concept of the present invention. As shown in FIG. 2, a compensated-clock generating circuit 1 includes an oscillating circuit 11, a counting circuit 2 that counts the number of clock pulses from the oscillating circuit 11, and a frequency compensation value generating circuit 16. The compensated-clock generating circuit 1 further includes a functional block 3 that generates a regular prescribed signal in accordance with a USB downstream signal. The counting circuit 2 has a counter 14 that counts the number of clock pulses from the oscillating circuit 11, and a count-value memory 15 capable of storing the number of clock pulses counted by the counter 14. The frequency compensation value generating circuit 16 previously stores a prescribed reference value of number of clock pulses from the oscillating circuit 11, compares this reference value with the value of the count, generates a compensation value of oscillation frequency and outputs this value to the oscillating circuit 11.

Further, the counting circuit 2 counts the clock pulses from the oscillating circuit 11 based upon a prescribed signal supplied from the functional block 3 at prescribed time intervals. By way of example, a trigger generating circuit 4 that receives the prescribed signal from the functional block 3 and generates a trigger based upon this signal is illustrated in FIG. 2. This is illustrated in order to simplify the description and it is permissible to incorporate the trigger generating circuit 4 in the counting circuit 2. In this case, it can be said that, in terms of appearance, the counting circuit 2 is counting the clock pulses based upon the prescribed signal. It should be noted that a concrete example of the trigger generating circuit 4 will be described later.

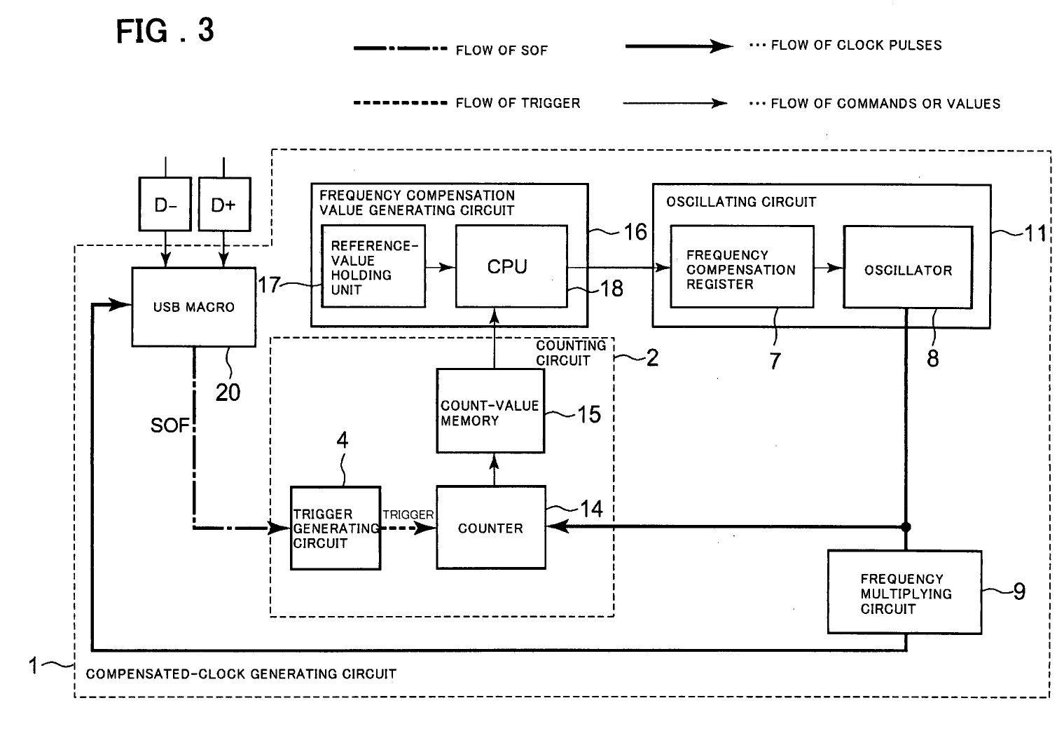

A first embodiment of the compensated-clock generating circuit 11 according to the present invention will be described based upon the block diagram of FIG. 3. The compensated-clock generating circuit 1 is implemented on a single LSI chip. Structural elements of this embodiment that differ will be described in comparison with the conceptual view of FIG. 2. The details of these structural elements will be described later. The trigger generating circuit 4 is provided within the counting circuit 2, by way of example. The compensated-clock generating circuit 1 has a USB macro 20, which corresponds to the functional block 3. The USB macro 20 transmits SOF (Start Of Frame), which is contained in a USB downstream signal, to the trigger generating circuit provided in the counting circuit 2. A concrete example of the trigger generating circuit will be described later. It should be noted that the USB macro, which comprises a hardware section for interpreting USB communication and a register for controlling the hardware section, is a functional block of a logic circuit that performs communication based upon USB specifications.

The SOF is one type of packet ID (referred to as “PID” below) that constitutes a SOF packet (frame-start packet) in the USB standard. The SOF is allocated as eight bits that follow an 8-bit sync field, which is for achieving synchronization, at the beginning of the frame-start packet. In other words, the SOF can be referred to as a PID for the frame-start packet. Accordingly, in the case of full-speed specifications, the SOF is incorporated in the USB downstream signal and supplied from an external USB host or from a USB-compliant hub as a frame-start packet every millisecond. It should be noted that unless it is specifically stated otherwise, the embodiment set forth in this specification will be described with regard to an example in which it is applied to the full-speed specification in order to simplify the description and facilitate understanding of the invention.

The frequency compensation value generating circuit 16 includes a reference-value holding unit 17 and a CPU 18. The oscillating circuit 11 includes a frequency compensation register 7 and an oscillator unit 8 comprising a CR phase-shift oscillator or a ring oscillator, etc. The compensated-clock generating circuit 1 further includes a frequency multiplying circuit 9 for frequency-multiplying the output of the oscillator circuit 11. It will suffice if the frequency compensation register 7 is one having a size that conforms to the number of compensation stages of the register. In this embodiment, the register 7 is an 8-bit register. Other structural elements having reference characters identical with those shown in FIG. 2 are identical elements and need not be described again. It should be noted that the reference-value holding unit 17 may be provided within the CPU 18 as a matter of course. Although such an arrangement is more convenient, here the reference-value holding unit 17 is illustrated as being outside the CPU 18 in order to facilitate the description.

The oscillation frequency of the oscillator 8 in oscillating circuit 11 need not be higher than the frequency necessary for a USB device and may be lower. The counter 14 of the counting circuit 2 is connected to the output of the oscillating circuit 11 and counts the number of clock pulses produced by the oscillating circuit 11. The timing of this operation is decided by the trigger generated in response to receipt of the SOF from the USB macro 20. The value of the count in the counter 14 of the counting circuit 2 is stored in the count-value memory 15. The frequency compensation value generating circuit 16 is constituted by the reference-value holding unit 17 and CPU 18. The CPU 18 compares the value in the count-value memory 15 with the reference value held in the reference-value holding unit 17 and outputs the result of computation to the oscillating circuit 11.

The result of computation that has been output is stored in the frequency compensation register 7 of the oscillating circuit 11 and the frequency of the oscillator 8 is corrected by this value. Clock pulses that are output from the oscillating circuit 11 are supplied to the USB macro 20 via the frequency multiplying circuit 9 in order to be used in USB communication. The USB macro 20 receives these highly accurate clock pulses and exchanges data and the like with the host or hub, not shown.

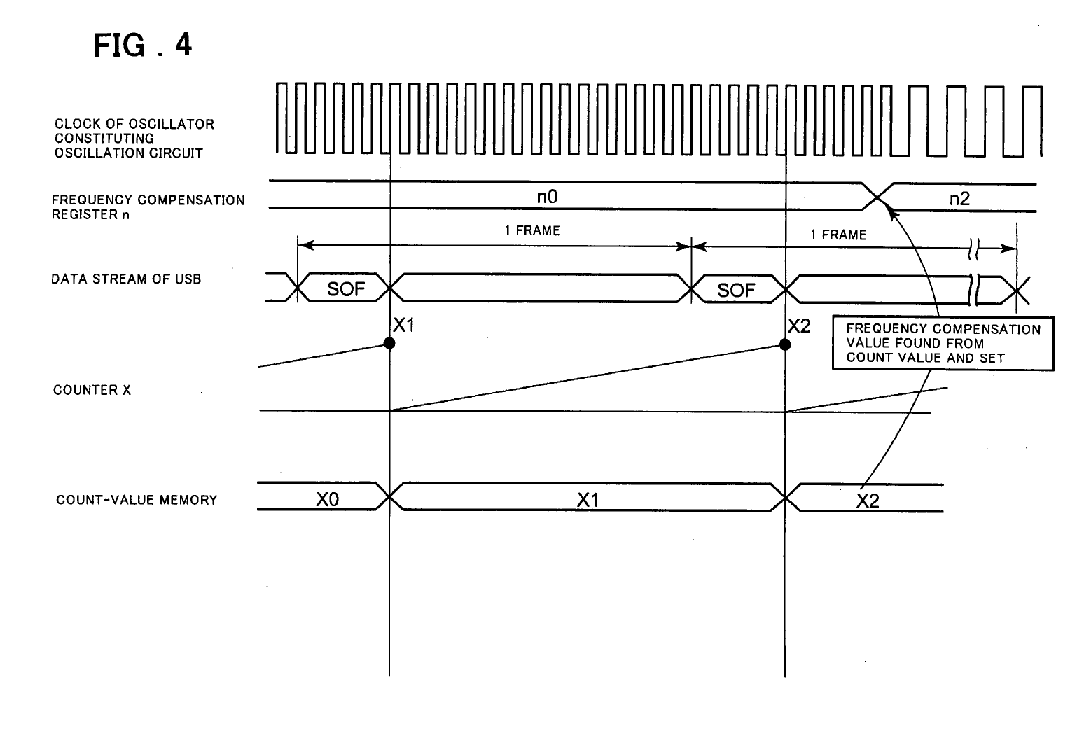

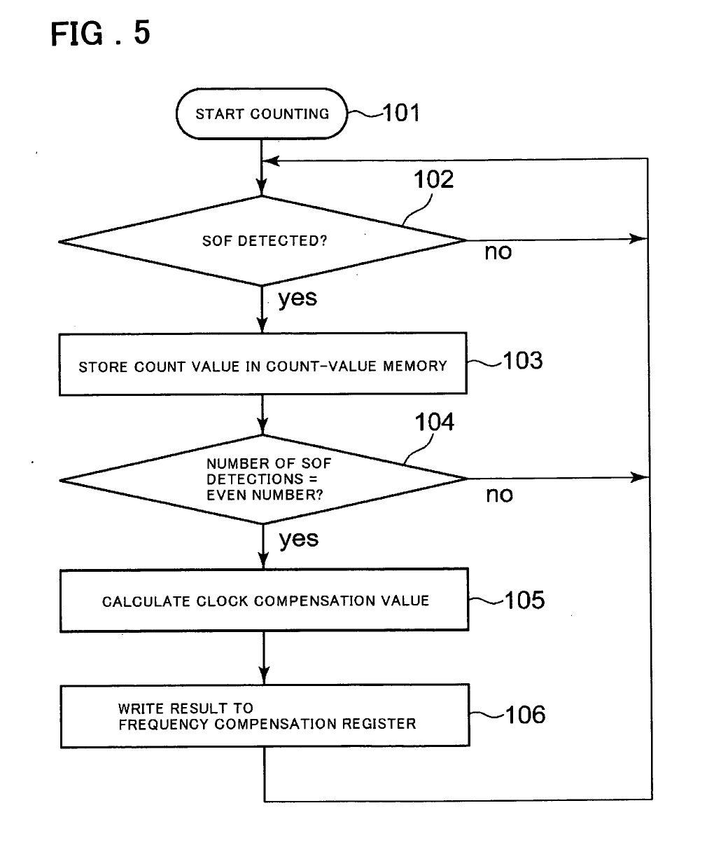

The operation of the first embodiment of the invention will be described in greater detail with reference to the timing chart of FIG. 4 and flowchart of FIG. 5 in addition to FIG. 3. When the compensated-clock generating circuit 1 of the present invention starts operating upon receiving power from a power-supply circuit (not shown), the oscillator 8 of the compensated-clock generating circuit 1 starts generating clock pulses. Further, the counter 14 also starts operating. Similarly, input signals (input data) in accordance with a USB data stream from an external host or hub compliant with the USB standard is received by the USB macro 20 from D+ and D− signal lines, and the USB macro 20 responds by generating the SOF.

The generation of the trigger in the trigger generating circuit 4 is performed based upon the SOF sent from the USB macro 20. A concrete example will be described later. The periodic SOF has an error of less than 0.05%. That is, one frame has a duration of one millisecond and the external host or the like transmits data in which the SOF can be recognized, i.e., the USB downstream signal, every millisecond. The USB macro 20 receives this signal and sends the SOF to the trigger generating circuit 4.

It should be noted that in the case where the counting circuit 2 is incorporated within the trigger generating circuit 4, it can be said that, in terms of appearance, the SOF is being sent to the counting circuit 2.

An example of the structure and operation of means for generating a trigger based upon an SOF, namely the trigger generating circuit 4, is as follows: When the SOF (specific data of eight bits) is received, a selector (not shown) within the trigger generating circuit detects the SOF and outputs a trigger generating command, and a pulse generating circuit (not shown) similarly provided internally generates the trigger. As mentioned earlier, the SOF is located ahead of each frame and is transmitted at highly accurate time intervals. By using the SOF, therefore, the clock pulses can be counted highly accurately.

The counter 14 of the counting circuit 2 counts the clock pulses from the oscillating circuit 11. More specifically, with reference to FIGS. 4 and 5, the USB macro 20 sends the SOF of the USB data stream to the counting circuit 2, and the trigger generating circuit 4 provided in the counting circuit 2 generates the trigger and sends it to the counter 14.

It should be noted that the USB data stream in FIG. 4 is shown to have only the SOF and not the sync field at the beginning in order to simplify the description. Although the names of the other portions of the data stream are left blank, USB-based packets such as IN, DATA and ACK are inserted into the blank area. This illustration indicates that in accordance with the USB specifications, data is sent and received during the one millisecond of one frame (in the case of the full-speed specifications) and the SOF is always provided ahead of the frame (following the Sync field, to be more exact).

The counter 14 receives the trigger that is based upon the SOF, resets the count value (X1) and starts counting again from zero. The counter 14 receives the trigger based upon the next SOF, sends the currently prevailing count value (X2) to the count-value memory 15 and resets the count value again.

The count-value memory 15 sends the count value X2 to the CPU 18 of the frequency compensation value generating circuit 16, the CPU 18 compares the count value X2 with the reference value being held in the reference-value holding unit 17 and finds the frequency compensation value. The CPU 18 further sets this frequency compensation value in the frequency compensation register 7 as a value such as n2, by way of example.

The oscillator 8 undergoes a frequency correction based upon the compensation value n2 and, as a result, the clock frequency of the oscillating circuit 11 is corrected. It should be noted that the clock pulses shown in FIG. 4 are drawn so as to emphasize the change in the pulses; usually the value of the actual correction is not as large as that construed from the diagram. When the trigger that is based upon next SOF (not shown) is received, a count value X3 (not shown) is loaded into the memory and the count value X3 is reset.

Thus, when the trigger that is based upon next SOF (not shown) is received, the count value X3 is loaded into the memory and the count value X3 is reset. However, the count value X3 is not compared with the reference value. The reason for this is as follows: Since the count value X2 is loaded by the second (even-numbered) SOF and compared with the reference value and the oscillator is corrected, the frequency during the period of the value X3 includes values that are in a state of fluctuation. Adopting this as the object of correction, therefore, is not particularly desirable. Naturally, if the correction can be performed at a high speed, the correction may be applied each time. In this embodiment, however, it is so arranged that the correction is made once every two triggers that are based upon the SOF.

The operation set forth above will be described in further detail with reference to the flowchart of FIG. 5. It should be noted that the value in the counter is generalized as Xn. The counting circuit starts counting at step 101 in FIG. 5. Next, the trigger based upon the SOF is detected (step 102) and the currently prevailing counter value Xn is stored in the count-value memory 15 (step 103). It should be noted that “SOF DETECTED?” is written as step 102 in order to simplify the illustration. More precisely, however, step 102 refers to detection of the trigger that is based upon the SOF. Next, at step 104, it is determined whether the number of times SOF has been detected is an even number of not. If it is an even number, then the clock compensation value is calculated (step 105). The calculated value is then written to the frequency compensation register 7 (step 106). This ends the series of steps. The calculation of the clock compensation value and the writing of the compensation value to the frequency compensation register 7 will be described later in greater detail.

In order to facilitate an understanding of the description, a method of calculating the clock compensation value and obtaining compensation value n in the frequency compensation register 7 will be described based upon a specific example. Operation is as follows in a case where the oscillating circuit 11 is to generate a frequency of 6 MHz, by way of example: The USB macro 20 generates the SOF at the 1-ms timing and detects the trigger signal based upon the SOF. If the frequency deviation is zero, therefore, the number of clock pulses between two triggers will be 6000. This number of clock pulses is adopted as the count reference value. Let Xs represent the count reference value. The reference value is sent from the CPU 18 to the reference-value holding unit 17. The SOF is detected as an even number of times, e.g., twice, as indicated at step 104 in the flowchart of FIG. 5, and the count value at such time is made Xn. A difference Y (%) between the count value and the reference value Xs is found from the following equation:
Y=[(Xn−Xs)/Xs]×100(%)
Furthermore, a clock compensation value C is found from the following equation:
C=Y/Y0
where Y0 represents the minimum unit of compensation (%) capable of being corrected by the frequency compensation register 7.

By way of example, if the count value Xn is 6060, the difference Y (%) between the count value and the reference value is as follows: Y=[(6060−6000)/6000]×100, i.e., 1%. Further, if we assume that Y0 is 0.10%, then the clock compensation value C is as follows: C=1.00/0.10=10. This value of 10 is the clock compensation value indicted at step 105 in FIG. 5. The result is written to the frequency compensation register 7 at step 106. Here the compensation value n in the frequency compensation register 7 is found to be n=n−C. The initial value of n is zero because it has not yet been corrected. This means that n=0−10=−10 holds. More specifically, a correction is applied that delays the frequency compensation register 7 by 10 units, i.e., by 1%. In other words, a correction that lowers the frequency is performed.

Thenceforth, since n is −10, the next compensation value undergoes a correction with respect to n (−10) and a similar compensating operation is performed from this point onward.

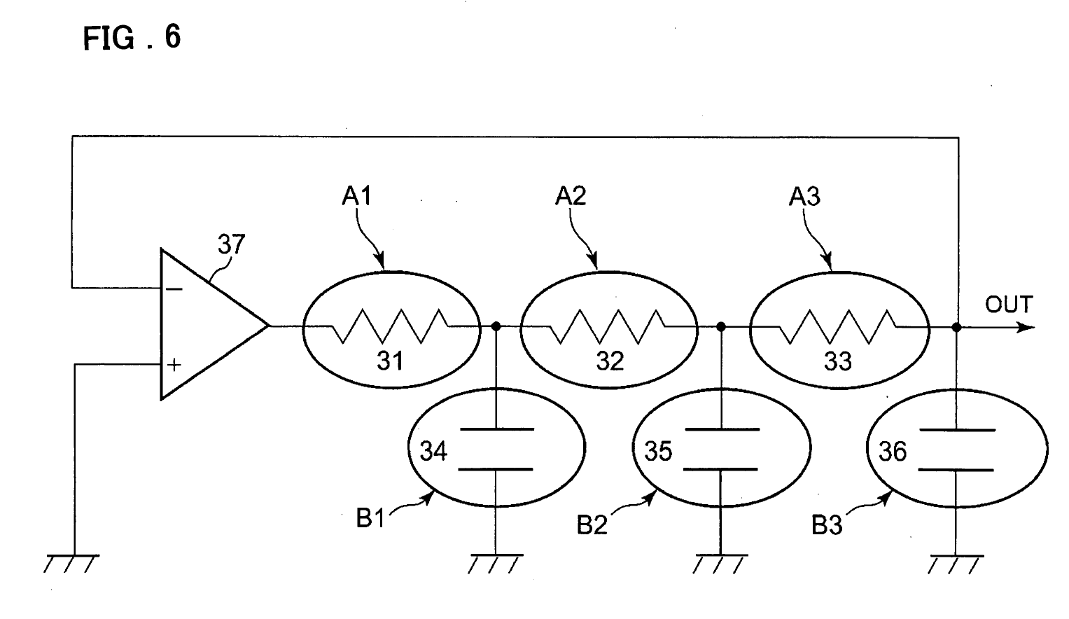

The frequency compensating operation of the oscillating circuit will be described in detail with reference to FIGS. 3 and 6. FIG. 6 is a block diagram illustrating the structure of the oscillator 8 used in the oscillating circuit 11 of the first embodiment. The oscillator 8 is a CR phase-shift oscillator and includes resistors 31, 32 and 33, capacitors 34, 35 and 36 and a regulator 37. Although three resistors and three capacitors are provided, more resistors and capacitors may be used.

In accordance with the value n that has been written to the frequency compensation register 7, control signals A1, A2, A3, B1, B2, B3 are applied to the resistors and capacitors from a circuit that is not shown, and the values of the resistors and capacitors are changed in accordance with the control signals, as a result of which the oscillation frequency changes. Further, well-known means constituted by switch circuits that are turned on and off in conformity with the compensation data may be used as means for varying the resistance values and capacitance values.

Although not illustrated, another method of implementing the oscillator 8 is to use a ring oscillator having multiple-staged CMOS inverter gates. This is a well-known method of changing oscillation frequency by changing the power-supply voltage of the inverter gates. In this case, it may be so arranged that the inverter-gate power-supply voltage is changed in conformity with the value in the frequency compensation register 7 when the oscillation frequency is corrected. More specifically, the method adopted is to pass a miniscule constant current through a resistor R by a constant-current source and thus change the power-supply voltage. The power-supply voltage in this case has the time-constant function of a resistor, and therefore the oscillation frequency of the ring oscillator is proportional to the resistor R. This makes it possible to correct the oscillation frequency.

Thus, in accordance with the first embodiment, the high-speed clock of an internal oscillator is not filtered. Rather, the high-speed clock per se is corrected based upon the difference in the clock of the internal oscillator. This makes it possible to obtain a prescribed frequency through a simple arrangement. Further, since the correction is applied in simple fashion using a USB macro, the above can be achieved at a low cost.

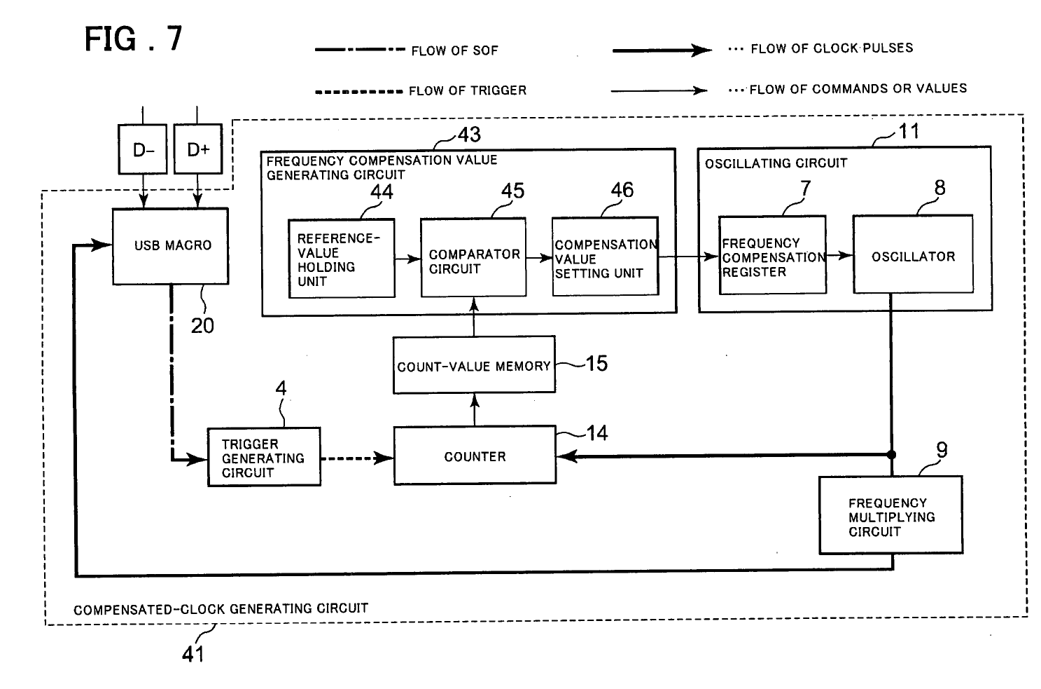

FIG. 7 is a block diagram of a compensated-clock generating circuit 41 according to a second embodiment implemented by hardware without the use of the CPU 18 while the functions of the frequency compensation value generating circuit 16 of the first embodiment are maintained substantially as is. The focus of the description that follows will be components that differ from those of the first embodiment.

A frequency compensation value generating circuit 43 includes a reference-value holding unit 44, a comparator circuit 45 and a compensation value setting unit 46. The count value reset every cycle corresponds to Xn. A reference value Xs in the reference-value holding unit 44, which is provided in the frequency compensation value generating circuit 43, is compared with the count value Xn by the comparator circuit 45, and the compensation value n is found in a manner similar to that of the first embodiment.

The hardware-implemented frequency compensation value generating circuit 43 is constructed as follows, by way of example: The reference-value holding unit 44 comprises, e.g., a memory, and the comparator circuit 45 comprises, e.g., a difference circuit. The compensation value setting unit 46 has, e.g., a correspondence table in which compensation values correspond to output values from the difference circuit, and includes a circuit for selecting a value, which corresponds to the output value of the difference circuit, as the compensation value.

In terms of operation of the frequency compensation value generating circuit 43, the comparator circuit 45 compares the reference value Xs from the reference-value holding unit 44 with the count value Xn and delivers the output of the difference circuit, namely a difference value, to the compensation value setting unit 46. The compensation value setting unit 46 outputs a compensation value that corresponds to this difference value and outputs this compensation value to the frequency compensation register 7 of the oscillating circuit 11.

By virtue of the arrangement described above, the frequency compensation value generating circuit can be implemented by hardware as well. As a result, the accuracy of the internal oscillator can be improved without imposing a load upon the CPU.

In accordance with the present invention, as set forth above, a compensated-clock generating circuit exhibiting a prescribed accuracy and a USB device using this circuit are obtained at low cost. It should be noted that the present invention is not limited to the foregoing embodiments. For example, it goes without saying that the amount of correction is not limited to the embodiments by writing the result of computation a register.

Further, an 8-bit register is employed in the embodiments. However, in order to realize even more accurate clock compensation, the register can be enlarged beyond eight bits, or the range of the prescribed amount of compensation can be narrowed. If possible, it is permissible to slightly enlarge the amount of correction as a matter of course.

In a case where the unit of correction is made finer, it is possible to obtain a clock accuracy necessary not only for the full-speed mode but also for high-speed communication that requires an accuracy higher than that of the full-speed mode. Further, it goes without saying that if the oscillator has a frequency necessary for USB communication, then a frequency multiplying circuit will not be necessary.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A compensated-clock generating circuit comprising:
an oscillating circuit that generates clock pulses;
a counting circuit that counts the number of clock pulses from said oscillating circuit based upon a regular prescribed signal in accordance with a USB downstream signal; and
a frequency compensation value generating circuit that compares the value counted by said counting circuit and a prescribed reference value and obtaining a compensation value;
wherein oscillation frequency of said oscillating circuit is corrected to a prescribed value in response to receipt of the compensation value from said frequency compensation value generating circuit.

2. The circuit according to claim 1, wherein said counting circuit has a trigger generating circuit that generates a trigger in response to receipt of the prescribed signal;
said counting circuit counting the number of clock pulses from said oscillating circuit in response to receipt of the trigger.

3. The circuit according to claim 1, further comprising a trigger generating circuit that generates a trigger in response to receipt of the prescribed signal;
said counting circuit counting the number of clock pulses from said oscillating circuit in response to receipt of the trigger.

4. The circuit according to claim 1, wherein the prescribed signal is an SOF that is based upon USB specifications.

5. The circuit according to claim 2, wherein the prescribed signal is an SOF that is based upon USB specifications.

6. The circuit according to claim 3, wherein the prescribed signal is an SOF that is based upon USB specifications.

7. The circuit according to claim 1, wherein the prescribed signal is generated by a USB macro provided in said compensated-clock generating circuit.

8. The circuit according to claim 2, wherein the prescribed signal is generated by a USB macro provided in said compensated-clock generating circuit.

9. The circuit according to claim 3, wherein the prescribed signal is generated by a USB macro provided in said compensated-clock generating circuit.

10. The circuit according to claim 4, wherein the prescribed signal is generated by a USB macro provided in said compensated-clock generating circuit.

11. The circuit according to claim 1, wherein said oscillating circuit includes a frequency compensation register and an oscillator that generates clock pulses;
a compensation value from said frequency compensation value generating circuit being held in said frequency compensation register, and oscillation frequency of said oscillator being corrected based upon an output from said frequency compensation register.

12. The circuit according to claim 1, wherein said compensated-clock generating circuit is built in a single semiconductor chip.

13. A USB device having the compensated-clock generating circuit set forth in claim 1.
